(19) United States
(12) Patent Application Publication
(10) Pub. No.: US 2009/0010243 A1
(43) Pub. Date: Jan. 8, 2009

(54) EXTENDED REAL-TIME POLLING SERVICE (ertPS) SCHEDULING SERVICE

(75) Inventor: GERRIT HIDDINK, Utrecht (NL)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/773,121

(22) Filed: Jul. 3, 2007

(51) Int. Cl. H04J 3/16

(52) U.S. Cl. 370/346

(57) ABSTRACT

A mobile station initiates an extended real-time polling service (ertPS) scheduling service talk-spurt period using a bandwidth allocation request (130) that contains a non-zero value for a number of allocation units (e.g., bytes) of uplink bandwidth requested by the mobile station and an individual connection identifier of an ertPS connection for the mobile station. If the mobile station receives an acknowledgement (140) addressed to the individual connection identifier and a bandwidth grant (160) addressed to a basic connection identifier of the mobile station, then it sends talk-spurt data (170). If no acknowledgement is received within a timeout period (150), the bandwidth allocation request (130) is re-transmitted. The existence of an acknowledgement (140) addressed to the individual connection identifier allows the mobile station to differentiate among various bandwidth grants that may be addressed to a basic connection identifier of the mobile station.

### FIELD OF THE DISCLOSURE

This disclosure relates generally to a method for scheduling uplink (UL) resources for an extended real-time polling service (ertPS).

### BACKGROUND OF THE DISCLOSURE

An Extended Real-Time Variable Rate (ERT-VR) data delivery service is defined in IEEE Std 802.16e-2005. ERT-VR service supports real-time applications with variable data rates, which require guaranteed data and delay, for example Voice over Internet Protocol (VoIP) with silence suppression. See IEEE Std 802.16e-2005 Section 6.3.20.1.5. VoIP often has a talk-spurt period (sometimes called an “active period”) followed by a silence period.

Section 6.3.5.2.2.1 of IEEE Std 802.16e-2005 defines an extended real-time polling service (ertPS) scheduling service that supports the ERT-VR data delivery service. It states that “The base station (BS) may provide periodic uplink (UL) allocations that may be used for requesting the bandwidth as well as for data transfer. By default, size of allocations corresponds to current value of Maximum Sustained Traffic Rate at the connection. The mobile station (MS) may request changing the size of the UL allocation by either using an extended piggyback request field of the Grant Management subheader or using bandwidth request (BR) field of the MAC signaling headers as described in Table 5a, or sending a codeword (defined in 8.4.5.4.10.13) over channel quality information channel (CQICH). The BS shall not change the size of UL allocations until receiving another bandwidth change request from the MS.”

Thus, when using ertPS, the periodic UL bandwidth allocation remains the same until the MS requests a different periodic UL bandwidth allocation. This methodology supports a talk-spurt period with variable data rates, provides for data and delay guarantees, and also limits the allocation of resources on both the UL and the downlink (DL) that may go unused or unneeded. During a silence period, as mentioned earlier, the MS may request a bandwidth allocation of zero.

Section 6.3.5.2.2.1 of IEEE Std 802.16e-2005 continues with “When the bandwidth request size is set to zero, the BS may provide allocations for only bandwidth request header or no allocations at all. In case that no unicast bandwidth request opportunities are available, the MS may use contention request opportunities for that connection, or send the CQICH codeword to inform the BS of its having the data to send. If the BS receives the CQICH codeword, the BS shall start allocating the UL grant corresponding to the current Maximum Sustained Traffic Rate value.”

As mentioned above, after an ertPS bandwidth request size is set to zero, a CQICH codeword (or an extended piggyback request field of a Grant Management subheader, or a BR field of a MAC signaling header, in a MAC protocol data unit) can be used to inform the BS that the MS has data to send. If the codeword or MAC protocol data unit (PDU) is properly received, the BS will allocate UL resources and the periodic ertPS allocations will resume.

If the CQICH codeword or MAC PDU is received with errors, however, the ERT-VR data flow will not be resumed. In an especially confusing situation, an uplink grant for a Best Effort scheduling service may be misinterpreted as an uplink grant for the ERT-VR scheduling service. In that case, the MS will be allocated insufficient bandwidth to support its connections, which will violate the real-time requirements of ERT-VR service. In the case of voice (VoIP) traffic, this will result in distorted audio.

FIG. 3 shows an example of a signal flow diagram 300 between a mobile station (MS) 303 and a base station (BS) 306 where a Best Effort uplink grant 372 is misinterpreted as an ERT-VR uplink grant. When a MS 303 has ERT-VR data to send to a BS 306, it initiates an initial ERT-VR service talk-spurt period 320 with a non-zero bandwidth allocation request 322.

If the bandwidth allocation request 322 is in the extended piggyback request field of a Grant Management subheader of a MAC protocol data unit, it will be in accordance with Table 10 of IEEE Std 802.16e-2005 and include the CID of the ertPS connection in the generic MAC header per Table 5 of IEEE Std 802.16-2004 Section 6.3.2.1.1. If the bandwidth allocation request 322 is in the BR field of a MAC signaling header in a MAC protocol data unit, it will be in accordance with Table 5a of IEEE Std 802.16e-2005 and include the CID of the ertPS connection in the BR header per Table 7 of IEEE Std 802.16-2004 Section 6.3.2.1.2. If the bandwidth allocation request is in a CQICH codeword, it will be governed by IEEE Std 802.16e-2005 Section 8.4.5.4.10.14, which has no provisions for including a CID.

When a bandwidth allocation request 322 is successfully received, the BS 306 allocates ertPS uplink resources 324 and transmits a bandwidth grant 332 addressed to the basic CID of the MS 303. IEEE Std 802.16e-2005 specifies that all bandwidth grants are addressed to the basic CID of a mobile station and not to individual CIDs.

When the bandwidth grant 332 is successfully received, the ERT-VR talk-spurt data 334 is transmitted. In response, to receiving talk-spurt data, another bandwidth grant 336 addressed to the basic CID is transmitted, and the data is periodically sent on the ertPS uplink as indicated by the repeat 338 sign.

When no data is available to send on the ERT-VR service, the MS 303 initiates a silence period 340 using a zero bandwidth allocation request 342. In other words, the MS 303 is asking the BS 306 to stop its periodic non-zero bandwidth allocations to the identified ertPS scheduling service. The zero bandwidth allocation request 342 can take the form of a zero value in an extended piggyback request field of a Grant Management subheader in a MAC PDU, or a zero value in a BR field of a MAC signaling header in a MAC PDU, similar to the non-zero bandwidth allocation request 332. If the MAC PDU is used, the CID of the ertPS connection is always included in the MAC PDU. (There is no CQICH code word mechanism to request a zero bandwidth allocation.) When the zero bandwidth allocation request 342 is successfully received, the BS 306 stops assigning 344 uplink resources to the MS 303.

When the MS 303 again has data to send, it starts another talk-spurt period 360 by transmitting another non-zero bandwidth allocation request 362. This request 362 is similar to the initial request 322. If the request 362 is in the form of a MAC PDU and is lost or corrupted during transmission, then the base station either does not receive it or the corrupted protocol data unit (PDU) will be discarded by the BS 306. If the request 362 is in the form of a CQICH codeword and is lost or corrupted during transmission, then either the CQICH feedback will not be received or the corrupted CQICH feedback will be interpreted as a standard Channel Quality Information Channel feedback (and not as a bandwidth allocation request) and acted upon as a standard CQI feedback or discarded by the BS if it falls outside the range of allowed values or does not seem consistent with the history of CQI values previously received.

Normally if a non-zero bandwidth allocation request 362 is lost or corrupted, no bandwidth grant will occur and the talk-spurt period 360 will not continue. In the situation shown in FIG. 3, however, the MS 303 has a separate Best Effort uplink active (in addition to the ERT-VR uplink with a talk-spurt period 360 being re-established) and a Best Effort bandwidth grant 372 is received by the MS 303 after the non-zero bandwidth allocation request 362 has been transmitted. Note that the Best Effort bandwidth grant 372 is not causally related to the ERT-VR request 362.

Given that the Best Effort bandwidth grant is addressed to the basic CID of the MS 303 in accordance with IEEE Std. 802.16-2004 Section 6.3.6.2, then the MS 303 misinterprets the Best Effort bandwidth grant 372 as a response to the ERT-VR request 362. Subsequently, the MS 303 transmits ERT-VR talk-spurt data 374 at the non-zero bandwidth requested in the ERT-VR request 362. Because it is unlikely that the Best Effort uplink resources allocated by the BS 306 provide enough bandwidth to satisfy the data and latency requirements of the ERT-VR service, the ERT-VR service will no longer be able to support the real-time service flows it was designed to support.

There is an opportunity to modify the ertPS scheduling service to provide for situations where the base station experiences reception errors such that a MAC PDU or CQICH codeword from a mobile station requesting resumption of periodic UL allocations is completely lost or else corrupted. The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows a flow chart for an extended real-time polling service (ertPS) scheduling service in accordance with an embodiment.

FIG. 2 shows an example of a signal flow diagram between a mobile station (MS) and a base station (BS) for a portion of an extended real-time polling service (ertPS) scheduling service session in accordance with an embodiment.

FIG. 3 shows an example of a signal flow diagram between a mobile station (MS) and a base station (BS) where a Best Effort uplink grant is misinterpreted as an ERT-VR uplink grant.

### DETAILED DESCRIPTION

A mobile station initiates an extended real-time polling service (ertPS) scheduling service talk-spurt period using a bandwidth allocation request that contains a first field for a non-zero value for a number of allocation units (e.g., bytes) of uplink bandwidth requested by the mobile station and a second field containing an individual connection identifier of an ertPS connection for the mobile station. If the mobile station receives an acknowledgement addressed to the individual connection identifier and a bandwidth grant address to a basic connection identifier of the mobile station, then it sends ertPS talk-spurt data using the number of allocation units of uplink bandwidth requested by the mobile station. If no acknowledgement is received within a timeout period, the bandwidth allocation request is re-transmitted.

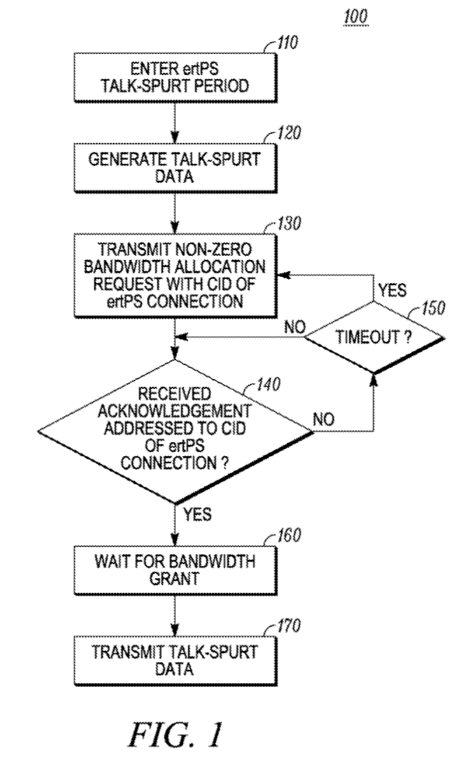

FIG. 1 shows a flow chart 100 for an extended real-time polling service (ertPS) scheduling service in accordance with an embodiment. When a mobile station has data to send using an Extended Real-Time Variable Rate (ERT-VR) data delivery service, it enters a talk-spurt period 110 by generating talk-spurt data 120 and transmitting a non-zero bandwidth allocation request 130. The non-zero bandwidth allocation request can take one of two forms. Both forms include a number of requested allocation units, which are specified as bytes in IEEE Std 802.16-2004 but could be different units such as kilobytes, and a connection identifier (CID) of the ertPS service. First, the request can be included in a Medium Access Control layer (MAC) protocol data unit (PDU) as an extended piggyback request in a Grant Management subheader per Table 10 of IEEE Std 802.16-2004. The extended piggyback request includes the number of bytes of uplink bandwidth requested by the mobile station. Also, the CID of the ertPS service will be included in the generic header of the MAC PDU per Table 5 of IEEE Std 802.16-2004. Second, the request can be included in a bandwidth request (BR) field of a MAC signaling header per Table 5a of IEEE Std 802.16e-2005 indicating the number of bytes of uplink bandwidth requested by the mobile station. The CID of the ertPS service will be included in the BR header of the MAC PDU per FIG. 20 of IEEE Std. 802.16-2004 Section 6.3.2.1.2. (Although a non-zero bandwidth allocation request can be in the form of a CQICH codeword (see IEEE Std. 802.16e-2005 Section 8.4.5.4.10.14), using a CQICH code word mechanism currently does not allow the inclusion of a CID of the ertPS connection and thus is not applicable here.)

Next, the mobile station checks if it has received an acknowledgement 140 addressed to the CID of the ertPS connection (“individual CID”). This acknowledgement can be in the format of a MAC management message, an extended subheader, or another type of message that includes the CID of the ertPS connection that is being resumed. If no acknowledgement is received, the mobile station proceeds to step 150 and waits for an acknowledgement with the individual CID unless a timeout period 150 elapses. If a timeout occurs, the non-zero bandwidth allocation request 130 with the individual CID is re-transmitted. When an acknowledgement with the individual CID is received, the mobile station waits for a bandwidth grant 160 to the basic CID of the mobile station. At this point, the mobile station transmits the talk-spurt data 170.

By waiting for an acknowledgement addressed to the CID of the ertPS connection, the mobile station will not confuse another bandwidth grant addressed to the basic CID for a bandwidth grant addressed to the ertPS connection. Thus, the non-zero bandwidth allocation request can be re-transmitted as necessary so that the data and delay requirements of ERT-VR can be maintained.

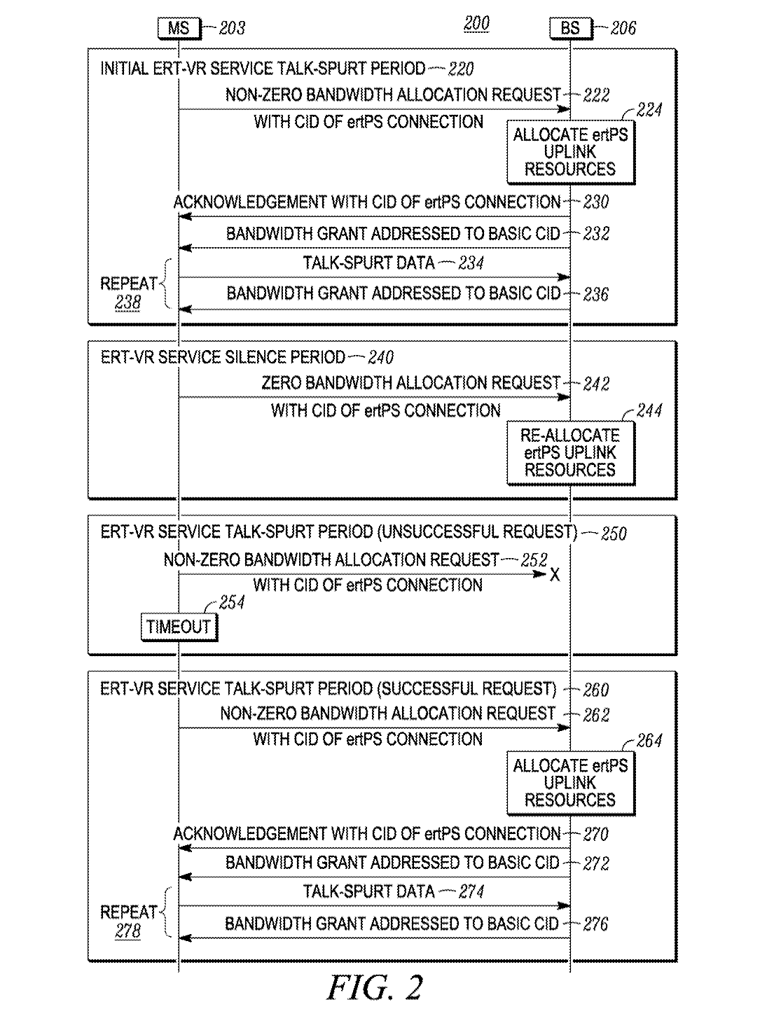

FIG. 2 shows an example of a signal flow diagram 200 between a mobile station (MS) 203 and a base station (BS) 206 for a portion of an extended real-time polling service (ertPS) scheduling service session in accordance with an embodiment. An initial ERT-VR service talk-spurt period 220 is initiated by a transmission of a non-zero bandwidth allocation request 222 from the MS 203 to the BS 206. If the request 222 is in the form of a MAC PDU, the PDU includes the number of bytes of uplink bandwidth requested by the MS 203 either in an extended piggyback request field or a bandwidth request field. The PDU also includes the CID of the ertPS connection—either as part of the generic MAC header or as part of a BR header.

If the request 222 is successfully received, the BS 206 allocates periodic uplink resources 224 and transmits an acknowledgement 230 including the CID of the ertPS connection. Then, the BS 206 transmits a bandwidth grant 232 addressed to the basic CID in accordance with IEEE Std. 802.16-2005 section 6.3.6.2. The MS 203 responds with the talk-spurt data 234 using the allocated period uplink resources, and the BS 306 responds with another bandwidth grant 236 addressed to the basic CID. The transmission of talk-spurt data and the reception of periodic bandwidth grants repeats 238 through the duration of the talk-spurt period 220.

When no more data is available, the MS 203 initiates an ERT-VR silence period 240 by transmitting a zero bandwidth allocation request 242. If the request 242 is in the form of an extended piggyback request in a MAC PDU, a zero value is sent in the extended piggyback request field of a Grant Management subheader in a MAC PDU. If the request 242 is in the form of a bandwidth request in a MAC PDU, a zero value is sent in the bandwidth request field of a MAC signaling header in a MAC PDU. Again, the CID of the ertPS connection is included elsewhere in the MAC PDU. When the BS 206 receives the zero bandwidth allocation request 242, it stops assigning the previously allocated ertPS uplink resources 244.

Next, the MS 203 again has ERT-VR data to send and transmits a non-zero bandwidth allocation request 252 including the CID of the ertPS connection in a MAC PDU. This situation will demonstrate an unsuccessful request 250 for an ERT-VR service talk-spurt period. This second non-zero bandwidth allocation request 252 is similar to the initial non-zero bandwidth allocation request 222. If the transmission is unsuccessful, the BS 206 will either not receive the request 252 or will receive a corrupted version of the request and not process it as a request. For example, if a PDU is received by the BS 206 and determined to be corrupted, it will be discarded by the BS 206 without being acted upon. In that situation, the BS 206 will not respond with a bandwidth grant addressed to the CID of the ertPS connection and the MS 203 timeout 254 will occur. See step 140 and step 150 of FIG. 1. Note that if a bandwidth grant to the basic CID of the MS 203 is received at this point in time, the MS will not misinterpret it as an ert-PS bandwidth grant and instead the timeout 254 will still occur.

Next, a successful request for an ERT-VR service talk-spurt period 260 will be shown. After a timeout 254, the MS 203 will retransmit the non-zero bandwidth allocation request 262 with the CID of the ertPS connection. This retransmission is identical to the unsuccessful request 252. If this transmission is successful, the BS 206 will allocate ertPS uplink resources 264 and transmit an acknowledgement 270 including the CID of the ertPS connection. Next, the BS 206 will transmit a bandwidth grant 272 addressed to the basic CID of the MS 203. When the MS 203 receives the acknowledgement 270 followed by the bandwidth grant 272, the MS 203 transmits talk-spurt data 274 and receives another periodic bandwidth grant 276 addressed to the basic CID of the MS 203. The talk-spurt data transmission and the bandwidth grant 276 reception repeats 278 until the end of the successful talk-spurt period 260.

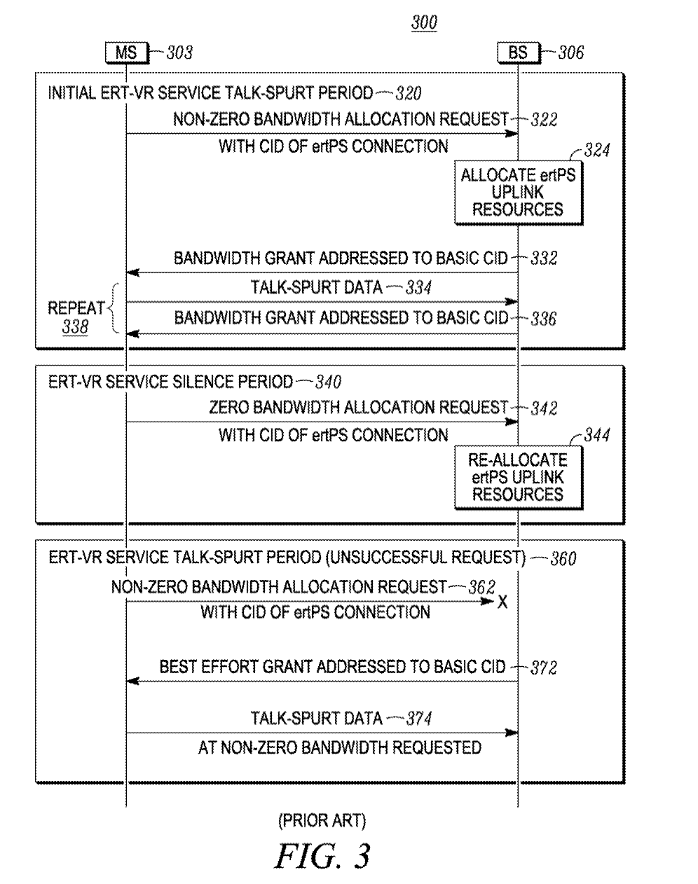

When a standard bandwidth grant (that is addressed to a basic CID of a mobile station) is received along with an acknowledgement to an individual CID of an ertPS connection, a mobile station will not confuse a bandwidth grant for one connection with a bandwidth grant for another connection. As contrasted in FIG. 2 and FIG. 3, the (best effort) bandwidth grant 372 addressed to a basic CID would not be confused with a bandwidth grant 272 addressed to a basic CID because if the mobile station failed to receive an acknowledgement 270 addressed to the CID of the ertPS connection, the bandwidth grant 272 (best effort or not) would not be considered a bandwidth grant to the ertPS connection. Avoiding this type of misinterpretation of a bandwidth grant message is particularly helpful for ERT-VR service, because of its strict data and delay requirements.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

As understood by those in the art, a controller can be used to implement the ertPS scheduling service within a mobile station. The controller includes a processor that executes computer program code to implement the methods described herein. Embodiments include computer program code containing instructions embodied in tangible media, such as floppy diskettes, CD-ROMs, hard drives, or any other computer-readable storage medium, wherein, when the computer program code is loaded into and executed by a processor, the processor becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

I claim:

1. A method for scheduling uplink resources for an extended real-time polling service (ertPS) of a mobile station comprising:
generating ertPS talk-spurt data;
transmitting a first bandwidth allocation request with a first field containing a non-zero value for a number of allocation units of uplink bandwidth requested by the mobile station and a second field containing an individual connection identifier of an ertPS connection for the mobile station;
receiving a first acknowledgement addressed to the individual connection identifier;
obtaining a first bandwidth grant addressed to a basic connection identifier of the mobile station; and
sending the ertPS talk-spurt data using the number of allocation units of uplink bandwidth requested by the mobile station.

2. A method according to claim 1 further comprising:
transmitting a second bandwidth allocation request with the first field containing a zero value for the number of allocation units of uplink bandwidth requested by the mobile station and the second field containing the individual connection identifier.

3. A method according to claim 2 further comprising:
generating further ertPS talk-spurt data;
transmitting a third bandwidth allocation request with the first field containing another non-zero value for a number of allocation units of uplink bandwidth requested by the mobile station and the second field containing the individual connection identifier;
receiving a second acknowledgement addressed to the individual connection identifier;
obtaining a second bandwidth grant addressed to the basic connection identifier of the mobile station; and
sending further ertPS talk-spurt data using the number of allocation units of uplink bandwidth requested by the mobile station.

4. A method according to claim 1 further comprising:
retransmitting the first bandwidth allocation request if the first acknowledgement is not received within a timeout period after the transmitting the first bandwidth allocation request.

5. A method according to claim 1 wherein the first bandwidth allocation request is an extended piggyback request of a Grant Management subheader in a medium access control layer (MAC) protocol data unit (PDU).

6. A method according to claim 1 wherein the first bandwidth allocation request is a bandwidth request of a Bandwidth request header in a medium access control layer (MAC) protocol data unit (PDU).
